(19) United States
(12) Patent Application Publication
(10) Pub. No.: US 2026/0259820 A1
(43) Pub. Date: Sep. 3, 2026

(54) WORKSPACE AUTOMATION BUILDER

(71) Applicant: ServiceNow, Inc., Santa Clara, CA (US)

(72) Inventors: Gopi Veeranki, Hyderabad (IN); Jayasree Veeraghanta, Hyderabad (IN); Andriy Blazhiyevskiy, Danville, CA (US); Eugene Vikutan, Sunnyvale, CA (US)

(21) Appl. No.: 19/068,697

(22) Filed: Mar. 3, 2025

(51) Int. Cl. G06F 11/3668; G06F 8/30

(52) U.S. Cl. CPC G06F 11/3684; G06F 8/30

(57) ABSTRACT

Embodiments of the subject technology relate to systems, methods, and computer-readable media for generating test code for workspace testing. Specifically, a response associated with performing a test in a workspace is inferred by a large language model based on received input. One or more elements can be identified in the workspace for performing the test based on the response. One or more drivers associated with performing operations through the one or more elements in the workspace are identified based on the response. Test code for automating the test is generated based on the response and the one or more drivers.

### BACKGROUND

### 1. Technical Field

The present disclosure generally relates to automated workspace testing, and more specifically to generating test code for automating a workspace test.

### 2. Introduction

Platforms have been developed that provide centralized functionality for managing various aspects of an environment, e.g. an enterprise environment. Specifically, platforms can provide interfaces and tools and support applications for managing records, workflows, collaboration tasks, and other administrative tasks through a centralized architecture for the environment. Such platforms can promote collaboration amongst users, increase productivity, and facilitate efficient management of tasks associated with the enterprise environment.

### BRIEF DESCRIPTION OF THE DRAWINGS

The various advantages and features of the present technology will become apparent by reference to specific implementations illustrated in the appended drawings. A person of ordinary skill in the art will understand that these drawings only show some examples of the present technology and would not limit the scope of the present technology to these examples. Furthermore, the skilled artisan will appreciate the principles of the present technology as described and explained with additional specificity and detail through the use of the accompanying drawings in which:

FIG. 1A illustrates a diagram of an example cloud computing architecture, according to some examples of the present disclosure;

FIG. 1B is a block diagram illustrating an example network architecture that can be used to implement one or more embodiments, components, devices, nodes, systems, instances, and/or portions of the example cloud computing architecture, according to some examples of the present disclosure;

FIG. 2 illustrates a schematic diagram of an architecture for generating test code for a workspace test, according to some examples of the present disclosure;

FIG. 3 illustrates a flowchart of an example method of inferring a response through an LLM to generate test code for a workspace test, according to some examples of the present disclosure;

FIG. 4 illustrates a flowchart of an example method of identifying candidate elements of a workspace test from an inferred response of an LLM and presenting the candidate elements to a user for selection for a workspace test, according to some examples of the present disclosure;

FIG. 5 illustrates a flowchart of an example method of generating test code for a test from driver wrapper code that is generated from an inferred response of an LLM, according to some examples of the present disclosure;

FIG. 6 illustrates a flowchart of an example method of generating test code for a workspace and automatically executing the test code based on user feedback, according to some examples of the present disclosure;

FIG. 7 is an example of a deep learning neural network that can be used to implement all or a portion of the systems and techniques described herein, according to some examples of the present disclosure;

FIG. 8 is a diagram illustrating an example architecture of an example transformer model, according to some examples of the present disclosure; and

FIG. 9 illustrates an example processor-based system with which some embodiments of the subject technology can be implemented, according to some examples of the present disclosure.

### DETAILED DESCRIPTION

The detailed description set forth below is intended as a description of various configurations of the subject technology and is not intended to represent the only configurations in which the subject technology can be practiced. The appended drawings are incorporated herein and constitute a part of the detailed description. The detailed description includes specific details for the purpose of providing a more thorough understanding of the subject technology. However, it will be clear and apparent that the subject technology is not limited to the specific details set forth herein and may be practiced without these details. In some instances, structures and components are shown in block diagram form to avoid obscuring the concepts of the subject technology.

Platforms have been developed that provide centralized functionality for managing various aspects of an environment, e.g. an enterprise environment. Specifically, platforms can provide interfaces and tools and support applications for managing records, workflows, collaboration tasks, and other administrative tasks through a centralized architecture for the environment. Such platforms can promote collaboration amongst users, increase productivity, and facilitate efficient management of tasks associated with the enterprise environment.

Platforms that provide centralized functionality for managing various aspects of an environment can be highly configurable across users and enterprises. Specifically, workspaces that are supported through the platforms can be both complex and highly configurable leading to a wide degree of variance across the workspaces. In turn, the variance and complexity of the workspaces can make it difficult to troubleshoot and test the workspaces. Specifically, writing tests for workspaces is a cumbersome and time-consuming process. Further, due to the complexity and variability of the workspaces, manually creating comprehensive test scripts is both inefficient and error prone.

The disclosed technology addresses the foregoing by facilitating creation of workspace tests in an automated or semi-automated manner. Specifically, a large language model (LLM) and other applicable artificial intelligence (AI)/machine learning (ML) models can be used to infer a response associated with performing a test in a workspace based on received input. The response can comprise a test file template with test steps for performing the test in the workspace. One or more elements in the workspace for performing the test can be identified based on the inferred response. Further, one or more drivers associated with performing operations through the one or more elements in the workspace can be identified based on the response. As follows, test code for automating the test can be generated based on the response and the one or more drivers. Specifically, the test code can be automatically generated based on the test file template and driver wrapper code generated for the one or more drivers in performing operations of the test steps through the one or more elements.

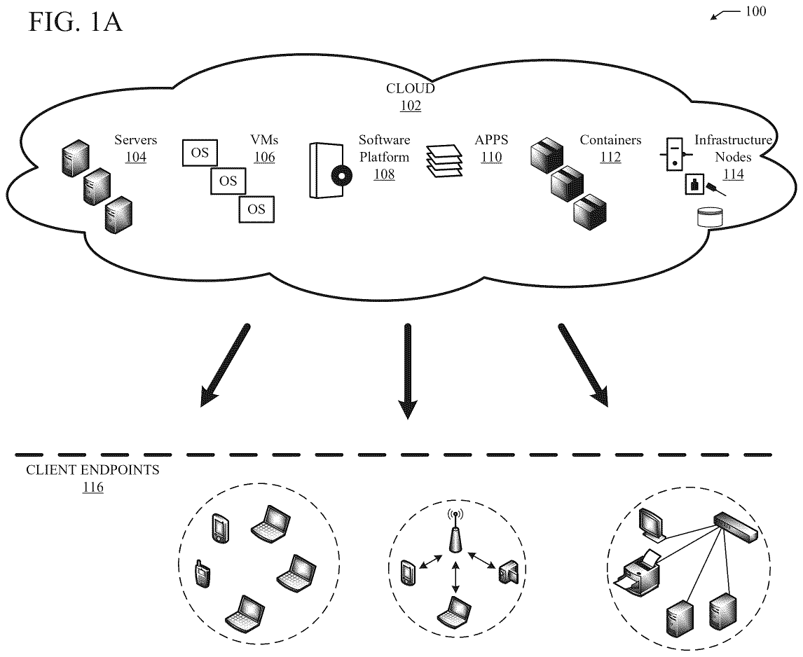

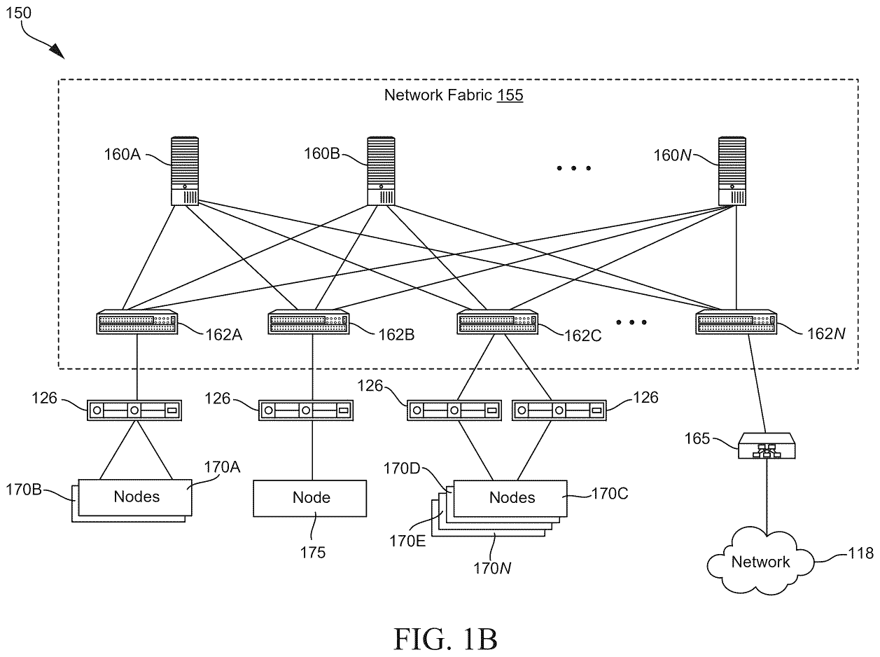

FIG. 1A illustrates a diagram of an example cloud computing architecture 100. The architecture can include a cloud 102. The cloud 102 can include one or more private clouds, public clouds, and/or hybrid clouds. Moreover, the cloud 102 can include cloud elements 104-114. The cloud elements 104-114 can include, for example, servers 104, virtual machines (VMs) 106, one or more software platforms 108, applications or services 110, software containers 112, and infrastructure nodes 114. The infrastructure nodes 114 can include various types of nodes, such as compute nodes, storage nodes, network nodes, management systems, etc.

The cloud 102 can provide various cloud computing services via the cloud elements 104-114, such as software as a service (SaaS) (e.g., collaboration services, email services, enterprise resource planning services, content services, communication services, etc.), infrastructure as a service (IaaS) (e.g., security services, networking services, systems management services, etc.), platform as a service (PaaS) (e.g., web services, streaming services, application development services, etc.), and other types of services such as desktop as a service (DaaS), information technology management as a service (ITaaS), managed software as a service (MSaaS), mobile backend as a service (MBaaS), etc.

The client endpoints 116 can connect with the cloud 102 to obtain one or more specific services from the cloud 102. The client endpoints 116 can communicate with elements 104-114 via one or more public networks (e.g., Internet), private networks, and/or hybrid networks (e.g., virtual private network). The client endpoints 116 can include any device with networking capabilities, such as a laptop computer, a tablet computer, a server, a desktop computer, a smartphone, a network device (e.g., an access point, a router, a switch, etc.), a smart television, a smart car, a sensor, a GPS device, a game system, a smart wearable object (e.g., smartwatch, etc.), a consumer object (e.g., Internet refrigerator, smart lighting system, etc.), a city or transportation system (e.g., traffic control, toll collection system, etc.), an internet of things (IoT) device, a camera, a network printer, or any smart or connected object (e.g., smart home, smart building, smart retail, smart glasses, etc.), and so forth.

In some cases, one or more embodiments, components, devices, nodes, systems, instances, and/or portions of the example cloud 102 can be implemented by and/or in a cloud network or datacenter. For example, any portion (or all) of the network 118, any of the content servers 120 (or all), and/or any of the system servers 126 (or all) can be implemented by and/or in a cloud network or datacenter. An example network architecture that can be used to implement any such network or datacenter (or any portion thereof), is shown in FIG. 1B and further described below.

FIG. 1B is a block diagram illustrating an example network architecture 150 that can be used to implement one or more embodiments, components, devices, nodes, systems, instances, and/or portions of the example cloud computing architecture 100, according to some examples of the present disclosure. The example network architecture 150 in FIG. 1B can represent, implement, deploy, host, support, include and/or provide the infrastructure for (or a portion of the infrastructure for) a datacenter (e.g., a cloud datacenter, an on-premises datacenter, a hybrid datacenter including private and public datacenters or datacenter portions, etc.), a network infrastructure, and/or any network environment (or portion thereof) such as, for example and without limitation, a cloud network/environment, a campus network/environment, an enterprise network/environment, an on-premises network/environment, a private network/environment, a public network/environment, a hybrid network/environment (e.g., a network/environment including both private and public networks/environments or portions thereof), and/or the like.

In some examples, the example network architecture 150 can host, implement, deploy, provide (e.g., provide the infrastructure for or a portion of the infrastructure for), support, and/or run/execute one or more applications, virtual machines (VMs), software containers, software tools, software functions, software algorithms, software models (e.g., artificial intelligence and machine learning models, software models implementing one or more classical algorithms, etc.), software applications, software packages, domains, databases, networks, services, workloads, service chains, functions, controllers, virtual network functions (VNFs), servers, drivers, hardware and/or software resources, software and/or hardware devices, software and/or hardware nodes, networking elements, serverless environments, serverless functions, cloud services and/or applications (e.g., software-as-a-service, function-as-a-service, infrastructure-as-a-service, platform-as-a-service, cloud applications, and/or any other cloud services and/or applications), execution environments, storage systems, processing/compute systems, memory systems, software and/or network sites, software policies, virtual/logical networks, overlay networks, software-defined networks (SDNs), interfaces, and/or any other code, component, element, application, service, etc.

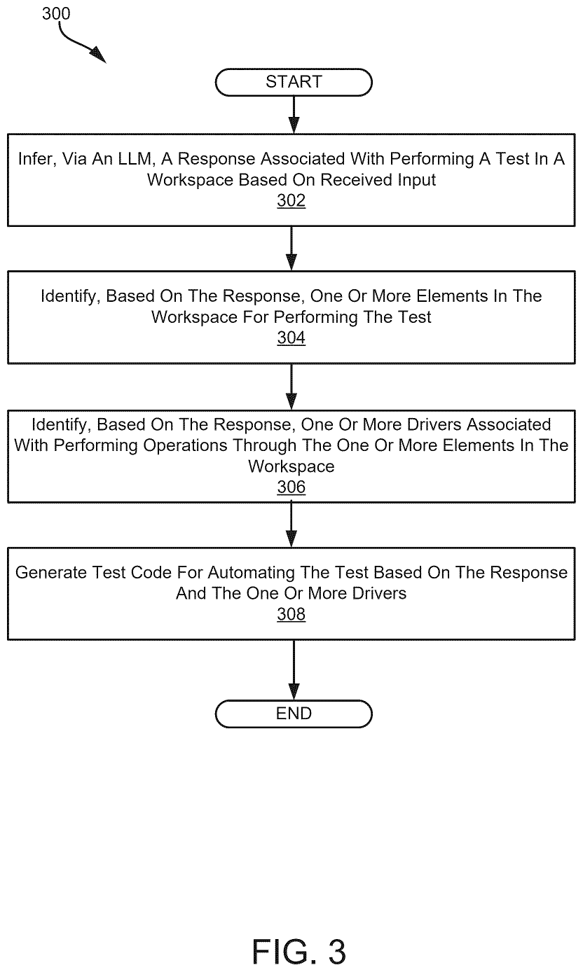

For example, the network architecture 150 can include, represent, implement, support, run, host, and/or provide the infrastructure for (or a portion of the infrastructure for) a datacenter, network (e.g., a cloud or cloud network, an on-premises network, a private network, a public network, a hybrid network, etc.), network infrastructure, and/or network environment used to host, implement, support, deploy, provide, and/or run quality control workloads/nodes, such as the worker nodes and the master node shown in FIG. 3 (and further described below). In such examples, the master node and each of the worker nodes can implement, include, represent, support, run, host, and/or provide one or more software applications/services, software systems, software packages, software modules, software units, software tools, interfaces, software/application code, functions, virtual environments, virtual applications, execution environments, virtualization elements (e.g., operating system-level virtualization elements, application-level virtualization elements, etc.), platforms, and/or any other components. In some cases, the master node and/or one or more of the worker nodes (or all) can each host and run one or more software containers, VMs, VNFs, applications (e.g., container applications, VM applications, and/or any other software applications), operating systems (OSs), functions, tools, and/or any other execution environment, code, tool, component, element, and/or package.

As shown in FIG. 1B, the network architecture 150 can include a network fabric 155. The network fabric 155 can include and/or represent the physical layer (e.g., underlay) and/or infrastructure of the network architecture 150. In some cases, the network fabric 155 can represent a data center(s) of one or more networks such as, for example, one or more cloud networks. The network fabric 155 can include network devices 160A-N (collectively referred to as “network devices 160” hereinafter) and network devices 162A-N (collectively referred to as “network devices 162” hereinafter), which are interconnected to route, relay, forward, and/or switch traffic in the network fabric 155. In some examples, the network devices 160 and the network devices 162 can include, implement, represent, and/or operate as switches (e.g., Layer 2 and/or Layer 3 switches, aggregation switches, ingress and/or egress switches, top-of-rack (ToR) switches, core switches, spine switches, leaf switches, etc.), routers, hubs, bridges, gateways, provider edge devices, firewalls, network controllers, and/or any other type of networking devices. In FIG. 1B, the network fabric 155 includes or implements a spine-leaf topology. In such examples, the network devices 160 can represent spine nodes (e.g., spine switches or routers) and the network devices 162 can represent leaf nodes (e.g., leaf switches or routers). In other examples, the network fabric 155 can alternatively or additionally include or implement any other network topology.

The network devices 160 are interconnected with the network devices 162, and the network devices 162 can connect the network 118, the system servers 126 (e.g., including QC system(s) 130 and configuration system(s) 132), the network device 165, the nodes 170, and/or the node 175 with any portion of the network fabric 155 (e.g., including each other), the media device(s) 106, the content servers 120, an external network(s), a network overlay(s), a logical network(s), a network portion(s) or branch/branches, an external device(s), a service chain(s), a data center(s), a cloud network(s), and/or any other network(s) and/or compute/network element(s). In some cases, the network fabric 155 can include, host, and/or implement a network overlay(s) or logical network(s) that includes or implements one or more application services, servers, VMs, software containers, virtual resources (e.g., storage, memory, processors, network interfaces, virtual tools, execution environments, etc.), workloads, functions, virtual networks, hardware and/or software resources, and/or any other element(s).

Network connectivity in the network fabric 155 can flow from the network devices 160 to the network devices 162, and vice versa. The network devices 162 can route, switch, relay, forward, and/or bridge network traffic to and from other portions of the network fabric 155, other networks, e.g. network 118, various network elements, the network device 165, the nodes 170, the node 175, external client devices (e.g., clients devices external to the network fabric 155), data centers, clouds, tunnels, software-defined networks (SDNs) and/or SDN branches, on-premises networks, cloud tenants, cloud customers, applications, and/or any other network element. Thus, the network devices 162 can connect networks and network elements of the network fabric 155 with each other and with other networks and network elements.

In FIG. 1B, the system servers 126 can include or represent computer servers. Each of the system servers 126 can host, include, implement, and/or run one or more applications, functions, services, VMs, software containers, service chains, workloads, AI/ML models, algorithms, resources, cloud appliances, and/or any other software. In some cases, the system servers 126 connected to the network devices 162 can encapsulate and decapsulate packets to and from the network devices 162. For example, the system servers 126 can include, host, implement and/or operate one or more virtual routers, switches, gateways, endpoints, and/or network devices for tunneling packets between an overlay or logical layer hosted by, or connected to, the system servers 126 and an underlay layer represented by or included in the network fabric 155.

As shown in FIG. 1B, the system servers 126 can host, include, run, operate, and/or implement the nodes 170 and the node 175. In some examples, the nodes 170 and the node 175 can represent cloud instances. For example, in some cases, the nodes 170 and the node 175 can each represent a virtual server and/or environment (e.g., a VM, a software container, etc.) that uses compute, memory, storage, and/or networking resources on the cloud (e.g., network architecture 150) for respective workloads. In some embodiments, the nodes 170 and/or the node 175 can perform parallel computing using, for example, multithreading. Each of the nodes 170 and/or the node 175 can include, host, implement, run, operate, and/or represent one or more server applications, software containers, VMs, software, services, AI/ML models, algorithms, cloud appliances, software functions, service chains, workloads, server-side functions, processing resources, computers, and/or any other software and/or hardware component.

For example, in some cases, each of the nodes 170 and/or the node 175 can represent a node instance that includes, implements, hosts, and/or runs a software container(s). The software container associated with a node can provide, run, deploy, include, operate, represent, and/or implement an execution environment(s), a workload(s), an application(s), software, an AI/ML model(s), an algorithm(s), a driver(s), a computer service(s), a software model(s) and/or algorithm(s), a function(s), a software library/libraries, a software tool(s), a software/cloud appliance(s), a software component(s), and/or any other computing element(s). In some cases, the nodes 170 and the node 175 can represent cloud node instances running respective computing environments, such as software containers or VMs. Each VM can include software, services, drivers, applications, libraries, functions, virtualized resources (e.g., processors, memory, storage, network interfaces, etc.), and/or workloads installed, implemented, included, and/or running/executed on a guest operating system (OS) associated with the VM.

The network architecture 150 can deploy, run, implement, host, and/or support various resources (e.g., hosts, applications, services, functions, VMs, software containers, workloads, cloud appliances, service chains, hardware and/or software resources, AI/ML models, algorithms, application platforms, operating systems, etc.) using the system servers 126, the network fabric 155, the network devices 160, the network devices 162, the network device 165, the nodes 170, the node 175, and the network 118.

In some cases, the network architecture 150 can implement and/or can be part of one or more cloud networks and can provide one or more cloud computing services such as, for example and without limitation, cloud storage, serverless computing, software-as-a-service (SaaS) (e.g., streaming services, content delivery services, video services, Internet content services, application services, conferencing services, etc.), infrastructure-as-a-service (IaaS), platform-as-a-service (PaaS) (e.g., web services, streaming services, content delivery services, content library services, conferencing services, video services, Internet content services, sharing and/or collaboration services, etc.), function-as-a-service (FaaS), and/or any other types of services such as desktop-as-a-service (DaaS), information technology management-as-a-service (ITaaS), managed software-as-a-service (MSaaS), mobile backend-as-a-service (MBaaS), etc.

The network architecture 150 described above illustrates a non-limiting example network architecture provided herein for explanation purposes. It should be noted that other network architectures can be implemented in other examples and are also contemplated herein. One of ordinary skill in the relevant art(s) will recognize in view of the disclosure that other network architectures can be used to implement one or more of the concepts, systems, techniques, devices, software, applications, methods, embodiments, elements, examples, and/or components disclosed herein.

Various embodiments of the subject technology can be implemented through the cloud computing architecture 100 shown in FIG. 1A and the network architecture 150 shown in FIG. 1B. In particular, machine learning (ML) models, LLMs, other applicable models, agents, and applications can be implemented through the architectures 100 and 150.

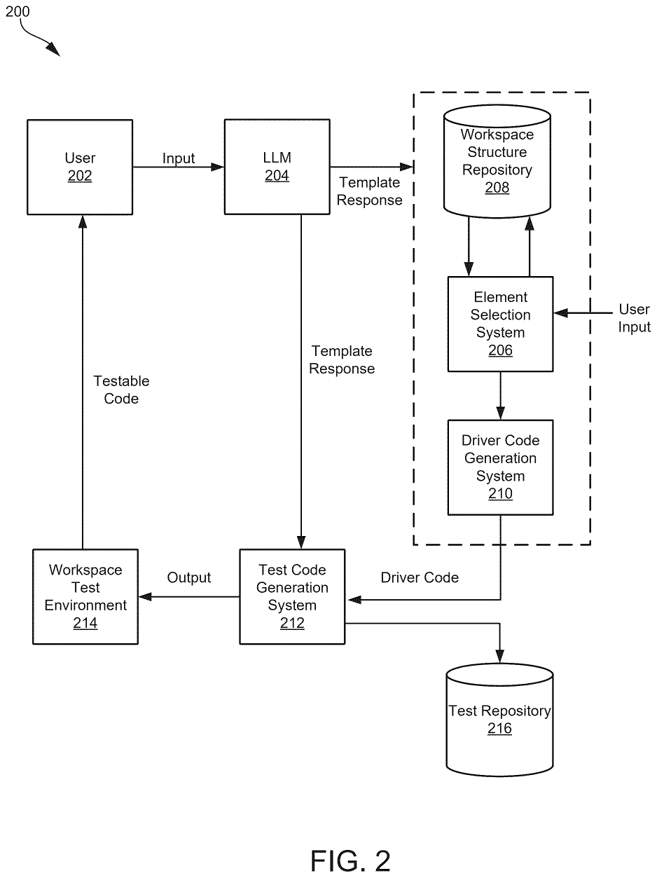

FIG. 2 illustrates a schematic diagram of an architecture 200 for generating test code for a workspace test, according to some examples of the present disclosure. The architecture 200 comprises a user 202. The user 202 can interact with the architecture through an applicable device. Further, the user 202 can provide input related to performing a workspace test.

A workspace, as used herein, can include an applicable environment in which computing tasks are performed. Specifically, a workspace can comprise an interface and functionalities that allow a user to interact with or otherwise implement an application. For example, a workspace can comprise functionalities, components, and data that facilitate user management of assets as part of an asset management application. Functionalities and components of the workspace can be implemented through elements of the workspace that are presented to a user and are activatable in performing the functionalities within the workspace. Specifically, the workspace can be in an applicable format, such as in a web page format with elements that can be accessed/activated through a web browser.

Input related to a workspace test, as used herein, can comprise applicable information defining a workspace test. A workspace, as used herein, can comprise specific test steps that are performed in performing the workspace test. Test steps can comprise specific functions/operations that are performed as part of performing the workspace test. Specifically, tests steps can specify which elements of a workspace to interact with in a specific manner and in a specific order in performing desired operations during the workspace test. Test input can be indicative of specific test steps to perform in a specific order as part of performing a workspace test. For example, test input can specify that a field is filled out and then a specific element to process data in the field is executed as part of a test step of a workspace test.

The test input can be provided by the user 202 in a natural language format or a semantic format that is interpretable by a human to define the workspace test. As will be discussed in greater detail, using test input that is in a natural language format or a semantic format that can be interpreted by a human to define a test to generate test code for the test is advantageous for many reasons. Specifically, a lay person, or someone who is unskilled in programming test code for performing tests, can provide input and effectively generate the test code for the test without any training or knowledge in programming.

The user 202 can interact with the architecture 200 through a plugin. Specifically, the user 202 can interact with the architecture 200 through a plugin of an application that is supporting a workspace, e.g. a workspace that is under test. More specifically, the user 202 can use the plugin to provide user input associated with testing a workspace, interact with a workspace that is under test, view candidate elements for selection as part of the test, and view generated test code.

The architecture comprises an LLM 204. The LLM 204 can comprise an applicable generative learning model for performing natural language processing or other processing modalities. Further, the LLM 204 can be part of a multimodal system or a unimodal system. The LLM 204 can function to receive input from the user 202 in relation to testing a workspace. In turn, the LLM 204 can use the input to infer a response for automatically generating test code for performing the workspace test.

A response inferred by the LLM 204 can comprise a test file template. A test file template that is inferred by the LLM 204 can comprise applicable information outlining a test file for performing a workspace test. Specifically, a test file template can comprise test steps for performing the workspace test. Further, a test file template can comprise actions to perform on specific elements in performing the test steps for the workspace test. A test file template can comprise the information outlining the test file but lack all or a portion of the actual test code that is executed, as part of a corresponding test file, in performing the workspace test. For example, the test file template can exclude all or portions of driver wrapper code that forms the test code for performing the workspace test.

The LLM 204 can recognize the workspace that is the subject of a test request/user input through a plugin and/or from the user input itself. Specifically, the user 202 can provide user input to the LLM 204 indicating test steps to perform on a specific workspace. The user 202 can access the workspace in association with providing the input to the LLM 204 through the plugin. As a result, the LLM 204 can recognize the workspace for performing the test through the plugin. For example, the user 202 can access an asset management workspace and provide input for testing the asset management workspace to the LLM 204 through the plugin. As follows, the LLM 204 can identify that the asset management workspace is under test through either or both the plugin and the input.

The architecture 200 also comprises an element selection system 206, a workspace structure repository 208, and a driver code generation system 210. In combination, the element selection system 206 and the driver code generation system 210 function to receive the inferred response from the LLM 204, e.g. the test file template/template response. As follows, the element selection system 206 and the driver code generation system 210 can perform functions for ultimately generating the driver code for the workspace test from the inferred response.

The element selection system 206 functions to identify elements for performing the test steps according to the test file template. Specifically, the element selection system 206 can traverse the workspace structure repository 208 to determine elements for performing the test steps of the workspace test. The workspace structure repository 208 can comprise applicable information regarding a structure of a workspace. Specifically, the workspace structure repository 208 can store information indicating the elements of workspaces including the workspace under test. More specifically, the workspace structure repository 208 can comprise a Document Object Model (DOM) for the workspace. As follows, the element selection system 206 can traverse the DOM for the workspace, according to the test file template, to select elements of the workspace that could be used in performing test steps of the test.

In identifying elements for performing the workspace test, the element selection system 206 can identify candidate elements for performing the workspace test. Specifically, the element selection system 206 can identify candidate elements by traversing the workspace structure repository 208 based on the test file template for the workspace test. Candidate elements can comprise elements that could potentially be used in performing tests steps of the workspace test. For example, a field can be associated with different elements that perform different actions on data in the field. The test file template can comprise test steps for testing the functionalities of the elements that manipulate data in the field. As a result, the element selection system 206 can identify the elements that perform different actions on data in the field as candidate elements for the workspace test.

The element selection system 206 can present candidate elements to the user 202. The element selection system 206 can present the candidate elements through an applicable interface through which the user 202 can interact with the architecture 200. In turn, the element selection system 206 can receive user input regarding the candidate elements. The input regarding the candidate elements can comprise applicable information of the candidate elements in relation to performing the workspace test. For example, the input regarding the candidate elements can specify which elements to use in the workspace test and which elements to exclude from the workspace test.

Presenting the candidate elements to the user 202 is technically advantageous as it can ensure that the workspace test is performed as specified by the user 202. Further, presenting the candidate elements to the user 202 can provide a check of the user's intent in the workspace test. Specifically, the user might provide test input to the LLM 204 that the user thinks accurately reflects their intent in the workspace test. However, the input might not accurately reflect the user's intent and the LLM 204, as a result, could have generated a test template with test steps that do not perform the intended workspace test. Therefore, presenting candidate elements of the workspace test to the user 202 provides an opportunity to recognize that the user's intent is not being carried through in the workspace test. As follows, the test input and test file template can be modified to properly account for the user's intent.

The element selection system 206 can inform the driver code generation system 210 of elements to use in the workspace test. These elements can include elements that are identified by the element selection system 206 and passed to the driver code generation system 210 without approval//selection by the user 202. Further, these elements can include elements that are identified by the element selection system 206 as candidate elements and then selected by the user 202.

The driver code generation system 210 functions to generate driver code, otherwise driver wrapper code, for performing test steps of the workspace test. Specifically, the driver code generation system 210 can generate driver code based on the elements identified by the element selection system 206. More specifically, the driver code generation system 210 can identify drivers for performing functionalities for the specific elements identified by the element selection system 206. In turn, the driver code generation system 210 can generate driver code for controlling the drivers associated with the specific elements. For example, the element selection system 206 can select a specific button for performing a test step of the workspace test. As follows, the driver code generation system 210 can select a driver for performing corresponding functions of the button. Further, the driver code generation system can generate test code for controlling the driver in performing the test step.

Further, the driver code generation system 210 can use the inferred response of the LLM 204 to generate the driver code for the selected drivers. Specifically, the driver code generation system 210 can use the inferred response of the LLM 204 to perform the operations of the test steps of the workspace test to generate the driver code for the selection drivers. More specifically, the driver code generation system 210 can use the test file template that is inferred by the LLM 204 to generate the driver code for the selected drivers. As discussed previously, the test file template can include test steps and corresponding operations for performing the workspace test. The driver code generation system 210 can then control execution of the identified drivers, e.g. driver wrappers, to perform the operations included in the test steps to generate the driver code for the drivers.

The architecture 200 also comprises a test code generation system 212. The test code generation system functions to generate the test code for automating the workspace test. The test code generation system can generate the test code based on the one or more drivers. More specifically, the test code generation system 212 can generate the test code based on the driver code generated by the driver code generation system 210 for the drivers identified by the element selection system 206. Further, the test code generation system 212 can generate the test code based on the response template generated by the LLM 204. Specifically, the test code generation system 212 can generate the test code test file template that is generate by the LLM 204 in response to the input provided by the user 202.

In generating the test code based on the driver code and the template response, the test code generation system 212 can merge the driver wrapper code generated by the driver code generation system 210 with the test file template inferred by the LLM 204. For example, the test code generation system 212 can fully construct a java file of test code based on the test file template and the driver wrapper code generated by the driver code generation system 210. Specifically, the LLM 204 can organize the driver wrapper code according to the test steps in the test file template and the operations specified by the test steps in the template to generate the test code for performing the workspace test.

Test code generated by the test code generation system 212 can be passed, as output, to the workspace test environment 214. The workspace test environment 214 serves as an environment in which the test code that is generated by the test code generation system 212 can be executed in performing the workspace test. Specifically, the test code can be automatically executed either in response to or regardless of received user feedback, e.g. feedback for accepting the test code. The workspace test environment 214 can be the actual workspace that the user 202 is accessing in providing input to the LLM 204 for conducting the workspace test. Further, the workspace test environment 214 can be a separate environment from the actual workspace that the user 202 is accessing. For example, the workspace test environment 214 can be accessed through a plugin. As follows, the user 202 can simultaneously view the actual workspace and the workspace under test in the separate workspace test environment 214. Regardless of the implementation, the workspace test environment 214 can support the workspace under test while the generated test code is executed in the environment.

As will be discussed in greater detail later, feedback can be provided based on the workspace test performed in the workspace test environment. Specifically feedback can be provided by an applicable AI model, such as the LLM 204. Further, feedback can be provided by the user 202. In turn, this feedback can be used to modify various functions performed in the architecture 200. Specifically, the input to the LLM 204 can be modified to either further refine user intent in the workspace test, or identify an error that occurred in the workspace test performed by the generated test code. For example, the input can specify that the element selection system 206 failed to identify an element in the workspace and that the workspace test should account for this element. In turn, a modified template response can be inferred by the LLM 204 and modified test code can be generated based on the modified template response according to the technology described herein.

The architecture 200 also comprises a test repository datastore 216. The test repository datastore 216 functions to store data related to generating test code for workspace tests through the architecture 200. Specifically, the test repository datastore 216 can store test code that is generated and an identification of a workspace/workspace test that is the subject of the test code. Further, the test repository datastore 216 can store different versions of test code. For example, the test repository datastore 216 can store different versions of test code as the test code is modified to different feedback. Further, the test repository datastore 216 can store test templates, e.g. test file templates generated by the LLM 204. Additionally, the test repository datastore 216 can store driver code, e.g. driver wrapper code, that is generated by the driver code generation system 210.

Data stored in the test repository datastore 216 can be used in future workspace tests. Specifically, if the same test is being performed, then already developed test code can be executed to perform the test instead of duplicating the test code. Further, data stored in the test repository datastore 216 can be used in generating test code for different workspace tests. For example, if a similar workspace test uses portions of already created test code, then the generated test code can be used in forming the test code for the workspace test without duplicating the code. Data stored in the test repository datastore 216 can be shared across different entities. For example, a first enterprise can develop a test code for a specific workspace test and store the test code in the test repository datastore 216. Further in the example, a second enterprise can use the test code that was developed by the first enterprise without having to independently develop the test code.

FIG. 3 illustrates a flowchart 300 of an example method of inferring a response through an LLM to generate test code for a workspace test, according to some examples of the present disclosure. The method shown in FIG. 3 is provided by way of example, as there are a variety of ways to carry out the method. Additionally, while the example method is illustrated with a particular order of steps, those of ordinary skill in the art will appreciate that FIG. 3 and the modules shown therein can be executed in any order and can include fewer or more modules than illustrated. Each module shown in FIG. 3 represents one or more steps, processes, methods or routines in the method. The modules will be discussed with respect to the example architectures described herein.

At module 302, a response associated with performing a test in a workspace is inferred based on received input. The input can be indicative of applicable information for performing a workspace test. Specifically, the input can be indicative of a workspace to test, test steps to perform during the workspace test, operations to perform during the test steps of the workspace test, and elements to interact with in performing the operations of the workspace test. The input can be in a natural language format or a semantic format that is interpretable by a human to define a workspace test. Specifically, the input can be in a format that is distinct from source code or an applicable programming language format.

The response inferred by the LLM can comprise applicable information for use in performing a workspace test. Specifically, the response can comprise test steps and operations to perform in the test steps in carrying out the workspace test. Further, the response can comprise an order in which to perform the test steps to carry out the workspace test. The response can be in an applicable format for generating code for a workspace. For example, the response inferred by the LLM can be in a JavaScript Object Notation (JSON) format.

At module 304, one or more elements in the workspace for performing the test are identified based on the response. Specifically, the one or more elements can be identified based on test steps and corresponding operations to perform during the workspace test, as inferred by the LLM. The one or more elements can be identified by traversing a DOM for the workspace according to the inferred response to select the one or more elements of the workspace that could be used in performing test steps of the test.

At module 306, one or more drivers associated with performing operations through the one or more elements in the workspace are identified based on the response. The drivers can be identified by accessing a GIT source repository associated with the workspace. Specifically, the GIT source repository can be searched based on the selected elements and the tests steps and corresponding operations in the inferred response to identify one or more drivers for performing the workspace test, e.g. the operations in the test steps.

At module 308, test code for automating the test is generated based on the response and the one or more drivers. Specifically, driver wrapper code can be generated based on the identified elements and the identified drivers. As follows, the driver wrapper code can be combined with the inferred response, e.g. a test file template, to generate test code for performing the test. In turn, the generated test code can be automatically executed. Specifically, the generated test code can be automatically executed after being created irrespective of received user feedback.

The modules of the flowchart 300 can be performed in an automated manner, or semiautomated manner, to effectively generate test for the performing the workspace test in an automated manner. Generating the test code in an automated manner or semiautomated manner is technically advantageous as it can save resources expended in generating the test code. Specifically, an engineer can spend hours manually scripting a test case and configuring a testing environment. Therefore, automatically generating the test code, e.g. with minimal human interaction, can save engineering resources. Further, manually scripting a test case is error-prone. Accordingly, automating the process of generating the test code for the workspace test can be reduce the presence of errors in the test code, as compared to if the code was manually scripted.

As discussed previously, the input that is used by the LLM to infer the response does not need to be provided in a programming language format, e.g. as human readable source code. Specifically, the input that is used by the LLM to infer the response can be in a natural language format. Therefore, as the response, as discussed with respect to modules 304, 306, and 308, is used to generate the test code for the workspace, the test code can be generated based on input in a natural language format. Generating the test code based on input in a natural language format is technically advantageous as a layperson, otherwise a user that is not skilled in programming languages, can effectively generate the test code. Specifically, a layperson can express their intent for the workspace test in a natural language format making it easier for the user to convey their intent, as opposed to if the intent had to be expressed in a programming language format. As a result, more people can create workspace tests, e.g. laypeople who lack programming knowledge. As follows, this can conserve engineering resources while allowing non-technical users to validate features of workspaces.

Further and as discussed previously, the LLM response can be in the JSON format. The JSON format is based on human-readable text but is also easy for machines to understand. Therefore, using a response in the JSON format to generate test code is technically advantageous as test code can be generated from input that is in a natural conversational format but can still be understood by a machine. Specifically, the use of the JSON format can ensure that the user's intent in the workspace test is accurately represented in the generated test code.

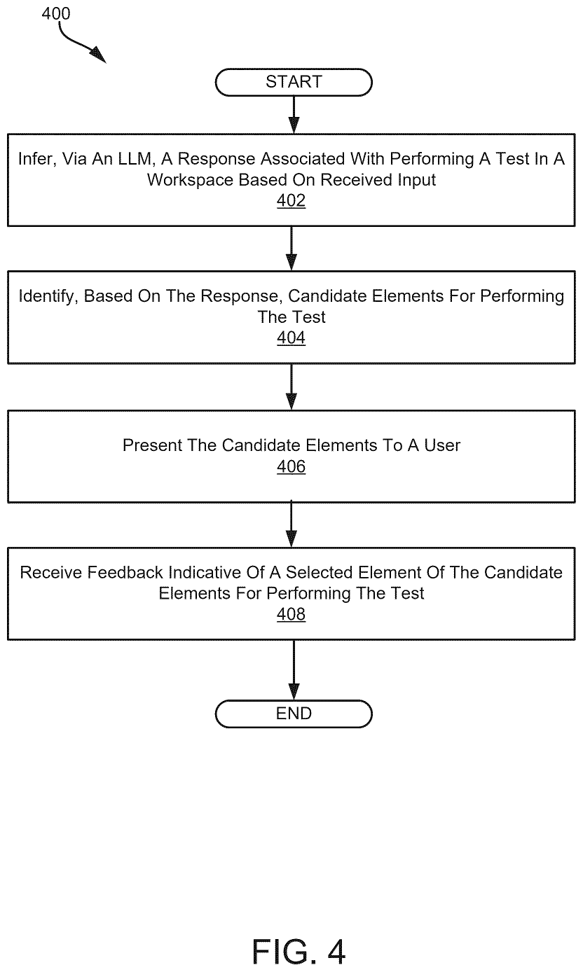

FIG. 4 illustrates a flowchart 400 of an example method of identifying candidate elements of a workspace test from an inferred response of an LLM and presenting the candidate elements to a user for selection for a workspace test, according to some examples of the present disclosure. The method shown in FIG. 4 is provided by way of example, as there are a variety of ways to carry out the method. Additionally, while the example method is illustrated with a particular order of steps, those of ordinary skill in the art will appreciate that FIG. 4 and the modules shown therein can be executed in any order and can include fewer or more modules than illustrated. Each module shown in FIG. 4 represents one or more steps, processes, methods or routines in the method. The modules will be discussed with respect to the example architectures described herein.

At module 402, a response associated with performing a test in a workspace is inferred by an LLM based on received input. The response can comprise applicable information for generating test code for performing a workspace test. Specifically, the response can comprise applicable information for generating test code for the workspace test that can be inferred from input in a natural language. For example, the response can comprise test steps for performing a test, operations to perform in the test steps, and an order for performing the test steps, otherwise a test file template for the workspace test.

At module 404, candidate elements for performing the test are identified based on the response. Specifically, candidate elements can be identified based on operations to be performed during the workspace test, as indicated by the inferred response, e.g. test file template. More specifically, elements that are potentially capable of performing operations during the workspace test can be identified. The candidate elements can be identified by traversing an appliable repository of data of the workspace's structure, such as a DOM for the workspace.

At module 406, the candidate elements are presented to a user. Specifically, the candidate elements are presented to the user so that the user can convey their intent of which elements to perform specific operations during the workspace test. The candidate elements can be presented through an interface that is separate from a current workspace in which the user is interacting. Alternatively, the candidate elements can be presented through an interface of a current workspace in which the user is interacting.

At module 408, feedback indicative of a selected element of the candidate elements for performing the test is received. Specifically, feedback of an element of the candidate elements that is selected by the user for performing the test is received. Providing the user with functionalities for viewing candidate elements and selecting candidate elements to use in conducting a workspace test is technically advantageous as the user can easily generate test code in a highly customizable manner. Specifically, users can create test code that is tailored to their specific scenarios and workflows. Further, providing the user with functionalities for viewing candidate elements and selecting candidate elements to use in conducting a workspace test is technically advantageous as users can discover issues in generating test code early in the process of generating the test code. Specifically, a user can ensure that proper elements are being used in generating the test code before the test code is actually generated. For example, if an intended element is not included in the candidate elements, then the user can provide further input for inferring a refined response for potentially selecting the appropriate candidate element.

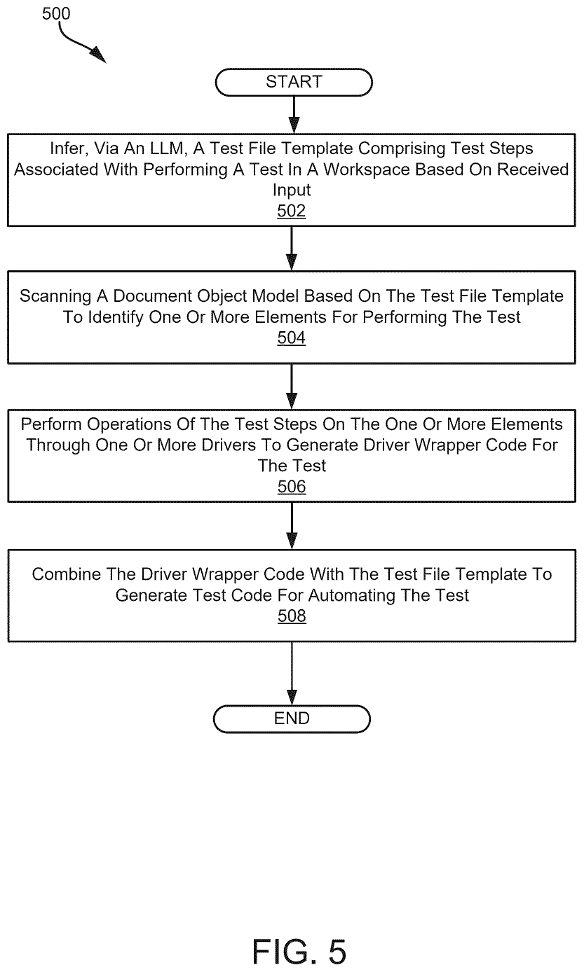

FIG. 5 illustrates a flowchart 500 of an example method of generating test code for a test from driver wrapper code that is generated from an inferred response of an LLM, according to some examples of the present disclosure. The method shown in FIG. 5 is provided by way of example, as there are a variety of ways to carry out the method. Additionally, while the example method is illustrated with a particular order of steps, those of ordinary skill in the art will appreciate that FIG. 5 and the modules shown therein can be executed in any order and can include fewer or more modules than illustrated. Each module shown in FIG. 5 represents one or more steps, processes, methods or routines in the method. The modules will be discussed with respect to the example architectures described herein.

At module 502, a test file template comprising test steps associated with performing a workspace test is inferred by an LLM based on received input. Specifically, the test file template can reflect the intent of a user in conducting a workspace test. The LLM can infer the test file template, at least in part, based on natural language input. Specifically, the LLM can infer the test file template without programming language input from the user.

At module 504, a DOM is scanned based on the test file template to identify one or more elements for performing the test. Specifically, the DOM can be scanned based on test steps and operations of the test steps in the test file template to identify one or more elements for performing the test. More specifically, the DOM can be scanned to identify elements that are capable of performing the test operations of the test steps of the test file template. The elements can be candidate elements that are identified and presented to the user for ultimate selection by the user.

At module 506, operations of the test steps are performed on the one or more elements through one or more drivers to generate driver wrapper code for the test. Specifically, one or more drivers for performing the operations of the test steps on the one or more elements can be selected based on the test file template. In turn, the operations can be performed on the selected driver(s) to generate driver wrapper code for the elements in performing the test steps of the workspace test. Automatically selecting the drivers and performing the test steps on the drivers is technically advantageous as engineers/developers can struggle to identify which driver wrapper performs an intended action during a workspace test. In turn, automatically selecting the driver and performing the test steps on the drivers can save engineering/developer resources.

At module 508, the driver wrapper code is combined with the test file template to generate test code for automating the test. Specifically, the driver wrapper code can be combined in the order of test steps in the test file template to generate test code for performing the operations of the workspace test according to the test file template. Identifying elements from the DOM, automatically generating driver wrapper code from the identified elements, and automatically generating the test code based on the driver wrapper code is technically advantageous as it can provide both consistency and uniformity of test automation design. Specifically, consistency and uniformity of test automation design can be achieved across multiple business units, otherwise divisions and departments within an enterprise. In turn, this can ensure that consistent processes, standards, and practices are met across the different divisions and departments of the enterprise.

The test file templates, driver wrapper code, and generated test code can be saved in repositories for future use across the different divisions and departments of an enterprise. This is technically advantageous as the saved data can be used to augment and edit existing and future workflows without the need for manual code refactoring. Further, this is technically advantageous as cross-team testing efforts are further facilitated. Specifically, teams not familiar with a product can still automate ad-hoc testing scenarios.

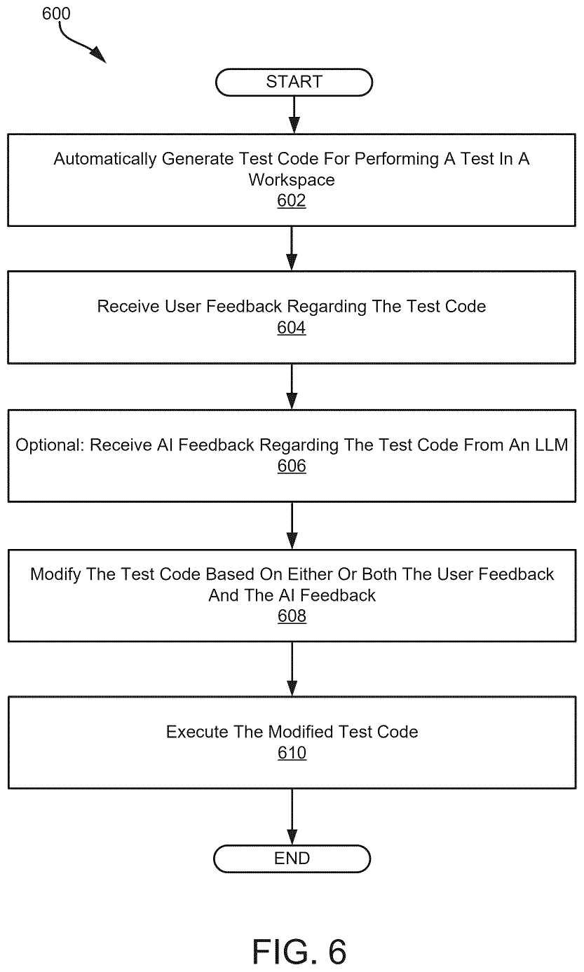

FIG. 6 illustrates a flowchart 600 of an example method of generating test code for a workspace and automatically executing the test code based on user feedback, according to some examples of the present disclosure. The method shown in FIG. 6 is provided by way of example, as there are a variety of ways to carry out the method. Additionally, while the example method is illustrated with a particular order of steps, those of ordinary skill in the art will appreciate that FIG. 6 and the modules shown therein can be executed in any order and can include fewer or more modules than illustrated. Each module shown in FIG. 6 represents one or more steps, processes, methods or routines in the method. The modules will be discussed with respect to the example architectures described herein.

At module 602, test code for performing a test in a workspace is automatically generated. The test code can be automatically generated using the technology described herein. Specifically, the test code can be automatically generated based on an inferred response to test input that is provided by a user and indicative of the user's intent in performing a workspace test.

At module 604, user feedback regarding the test code is received. Feedback can be received from the same user that provided the input to generate the test code. The feedback can indicate whether the test code is satisfactory and what changes to make in modifying the test code to achieve the user's intent in performing the workspace test. Further, the feedback can indicate deficiencies in the test code. In facilitating receipt of the user feedback, the generated test code can be automatically executed and the results can be returned to a user. In turn, the user can provide their feedback, e.g. in the form of a natural language prompt.

At optional module 606, AI feedback regarding the test code is received from an LLM. The feedback can indicate whether the test code is satisfactory and changes to make in modifying the test code to achieve the user's intent in performing the workspace test. Further, the feedback can indicate deficiencies in the test code. Additionally, the feedback can indicate a ranking or score of the test code, e.g. with respect to code that is generated for other workspace tests. In facilitating receipt of the AI feedback, the generated test code can be automatically executed and the results can be analyzed by the LLM. In turn, LLM can provide feedback based on the results of automatically executing the test code.

At module 608, the test code is modified based on either or both the user feedback and the AI feedback. Specifically, the LLM that is used in generating the test code can access the provided feedback and infer a new response. More specifically, the LLM can infer a response that comprises changes to a previous test file template or a new test file template. As follows, the technology applied herein can be applied based on the new response to generate modified test code. Specifically, new elements can be identified for performing test steps as part of the modified test code and new test steps as part of the modified test code can be identified. As follows, drivers can be identified and driver wrapper code can be generated based on the new response. The driver wrapper code can then be used to generate the modified test code based on the new response.

At module 610, the test code is executed. Specifically, the modified test code can be automatically executed irrespective of instructions to execute the test code from a user or other authority. Alternatively, the modified test code can be executed after the modified test code is presented to and accepted by the user. This process of receiving feedback, modifying the test code based on the feedback and executing the modified code can continue in a loop, e.g. until test code is generated that satisfies the user's intent for performing the workspace test.

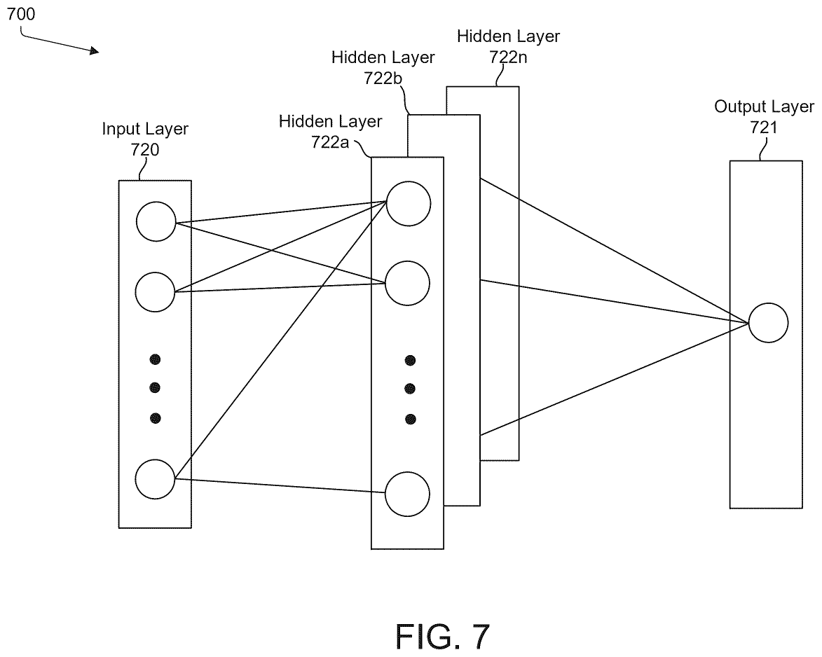

In FIG. 7, the disclosure now turns to a further discussion of models that can be used to implement the technology described herein. FIG. 7 is an example of a deep learning neural network 700 that can be used to implement all or a portion of the systems and techniques described herein, according to some examples of the present disclosure. An input layer 720 can be configured to receive data. Neural network 700 includes multiple hidden layers 722a, 722b, through 722n. The hidden layers 722a, 722b, through 722n include “n” number of hidden layers, where “n” is an integer greater than or equal to one. The number of hidden layers can be made to include as many layers as needed for the given application. Neural network 700 further includes an output layer 721 that provides an output resulting from the processing performed by the hidden layers 722a, 722b, through 722n.

Neural network 700 is a multi-layer neural network of interconnected nodes. Each node can represent a piece of information. Information associated with the nodes is shared among the different layers and each layer retains information as information is processed. In some cases, the neural network 700 can include a feed-forward network, in which case there are no feedback connections where outputs of the network are fed back into itself. In some cases, the neural network 700 can include a recurrent neural network, which can have loops that allow information to be carried across nodes while reading in input.

Information can be exchanged between nodes through node-to-node interconnections between the various layers. Nodes of the input layer 720 can activate a set of nodes in the first hidden layer 722a. For example, as shown, each of the input nodes of the input layer 720 is connected to each of the nodes of the first hidden layer 722a. The nodes of the first hidden layer 722a can transform the information of each input node by applying activation functions to the input node information. The information derived from the transformation can then be passed to and can activate the nodes of the next hidden layer 722b, which can perform their own designated functions. Example functions include convolutional, up-sampling, data transformation, and/or any other suitable functions. The output of the hidden layer 722b can then activate nodes of the next hidden layer, and so on. The output of the last hidden layer 722n can activate one or more nodes of the output layer 721, at which an output is provided. In some cases, while nodes in the neural network 700 are shown as having multiple output lines, a node can have a single output and all lines shown as being output from a node represent the same output value.

In some cases, each node or interconnection between nodes can have a weight that is a set of parameters derived from the training of the neural network 700. Once the neural network 700 is trained, it can be referred to as a trained neural network, which can be used to classify one or more activities. For example, an interconnection between nodes can represent a piece of information learned about the interconnected nodes. The interconnection can have a tunable numeric weight that can be tuned (e.g., based on a training dataset), allowing the neural network 700 to be adaptive to inputs and able to learn as more and more data is processed.

The neural network 700 is pre-trained to process the features from the data in the input layer 720 using the different hidden layers 722a, 722b, through 722n in order to provide the output through the output layer 721.

In some cases, the neural network 700 can adjust the weights of the nodes using a training process called backpropagation. A backpropagation process can include a forward pass, a loss function, a backward pass, and a weight update. The forward pass, loss function, backward pass, and parameter/weight update is performed for one training iteration. The process can be repeated for a certain number of iterations for each set of training data until the neural network 700 is trained well enough so that the weights of the layers are accurately tuned.

To perform training, a loss function can be used to analyze error in the output. Any suitable loss function definition can be used, such as a Cross-Entropy loss. Another example of a loss function includes the mean squared error (MSE), defined as E_total=Σ(½(target-output)^2). The loss can be set to be equal to the value of E_total.

The loss (or error) will be high for the initial training data since the actual values will be much different than the predicted output. The goal of training is to minimize the amount of loss so that the predicted output is the same as the training output. The neural network 700 can perform a backward pass by determining which inputs (weights) most contributed to the loss of the network, and can adjust the weights so that the loss decreases and is eventually minimized.

The neural network 700 can include any suitable deep network. One example includes a Convolutional Neural Network (CNN), which includes an input layer and an output layer, with multiple hidden layers between the input and out layers. The hidden layers of a CNN include a series of convolutional, nonlinear, pooling (for downsampling), and fully connected layers. The neural network 700 can include any other deep network other than a CNN, such as an autoencoder, Deep Belief Nets (DBNs), Recurrent Neural Networks (RNNs), among others.

As understood by those of skill in the art, machine-learning based classification techniques can vary depending on the desired implementation. For example, machine-learning classification schemes can utilize one or more of the following, alone or in combination: hidden Markov models; RNNs; CNNs; deep learning; Bayesian symbolic methods; Generative Adversarial Networks (GANs); support vector machines; image registration methods; and applicable rule-based systems. Where regression algorithms are used, they may include but are not limited to: a Stochastic Gradient Descent Regressor, a Passive Aggressive Regressor, etc.

Machine learning classification models can also be based on clustering algorithms (e.g., a Mini-batch K-means clustering algorithm), a recommendation algorithm (e.g., a Minwise Hashing algorithm, or Euclidean Locality-Sensitive Hashing (LSH) algorithm), and/or an anomaly detection algorithm, such as a local outlier factor. Additionally, machine-learning models can employ a dimensionality reduction approach, such as, one or more of: a Mini-batch Dictionary Learning algorithm, an incremental Principal Component Analysis (PCA) algorithm, a Latent Dirichlet Allocation algorithm, and/or a Mini-batch K-means algorithm, etc.

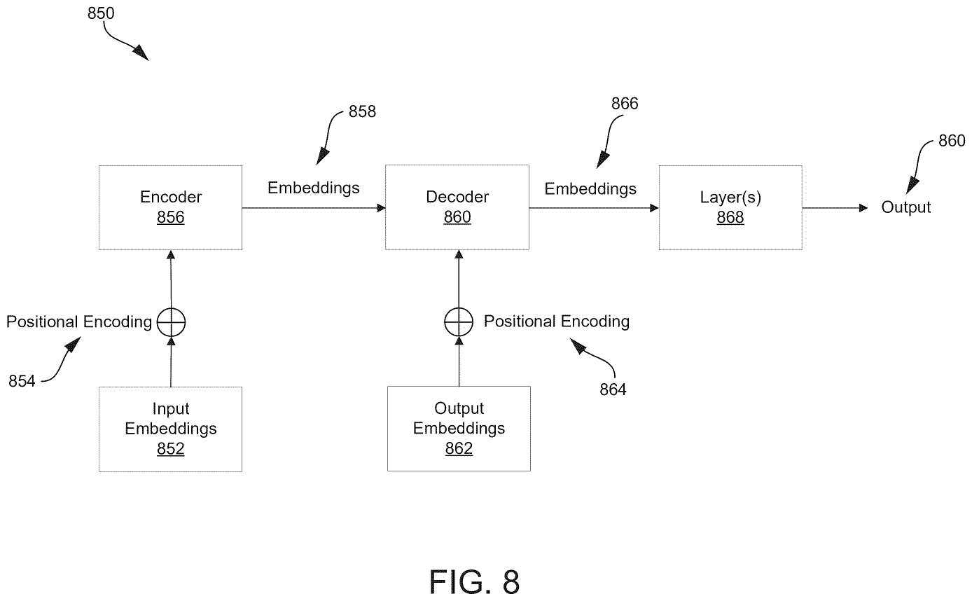

FIG. 8 is a diagram illustrating an example architecture of an example transformer model 850, according to some examples of the present disclosure. The transformer model 850 can be used to implement an LLM that can be used to implement the technology described herein. As shown, the transformer model 850 can include input embeddings 852 used as inputs to the transformer model 850. The input embeddings 852 can include input values representing words and/or sentences, such as numbers or vectors representing words and/or sentences.

In some cases, the input embeddings 852 can function like a dictionary that helps the transformer model 850 understand the meaning of words by placing them in an embedding space where similar words are located near each other. In some examples, the input interface 134 can be trained and/or configured to create the input embeddings 852 so that similar vectors represent words with similar meanings. In some examples, the transformer model 850 can additionally or alternatively learn to create and/or process the input embeddings 852 during training.

The transformer model 850 can use positional encoding 854 to encode the position of each word in an input sequence from the input embeddings 852 as values such as a set of numbers, a vector, etc. The values generated by the positional encoding 854 can be fed into the transformer model 850 along with the input embeddings 852. By incorporating the positional encoding 854 into the transformer model 850, the transformer model 850 can more effectively understand the order of words in a sentence and generate grammatically correct and semantically meaningful output.

The transformer model 850 can include an encoder(s) 856 used to process the positionally encoded input embeddings 852 and generate embeddings 858. The encoder(s) 856 can be part of the transformer model 850 that processes input text and generates hidden states that capture the meaning and context of the text. For example, the encoder(s) 856 can include a feed-forward neural network that is part of the transformer model 850. In some examples, the encoder(s) 856 can implement multiple encoder layers. In some cases, the encoder(s) 856 can first tokenize the input text into a sequence of tokens, such as individual words or subwords. The encoder(s) 856 can then apply one or more self-attention layers, which can generate hidden states that represent the input text at different levels of abstraction. In this way, the encoder(s) 856 can generate the embeddings 858 (e.g., a vector, a set of values, etc.) representing the semantics and position of words in one or more sentences.

The transformer model 850 can include output embeddings 862, which can include values representing words and/or sentences, such as numbers or vectors representing words and/or sentences. The output embeddings 862 can be similar to the input embeddings 852 and can also be processed by positional encoding 864 to encode the position of each word in a sequence from the output embeddings 862 as values such as a set of numbers, a vector, etc., which helps the transformer model 850 understand the order of words in a sentence. The output embeddings 862 can be used during a training phase of the transformer model 850 and can be used during an inference phase. During training, a loss function can be computed based on the output embeddings 862 and used to update the model parameters to improve the accuracy of the transformer model 850. During an inference phase, the output embeddings 862 can be used to generate the output text by mapping the predicted probabilities determined by the transformer model 850 for each token to the corresponding token in the vocabulary.

The positionally encoded input embeddings 852 (e.g., the embeddings 858) and the positionally encoded output embeddings 862 can be fed to a decoder(s) 860 used to generate the output sequence based on the encoded input sequence. During training, the decoder(s) 860 can learn how to guess the next word of a sequence by looking at the words before it. In some examples, the decoder(s) 860 can generate natural language text based on the input sequence and any learned context.

The decoder(s) 860 can generate embeddings 866 and feed the embeddings 866 to one or more network layers 868. In some examples, the one or more network layers 868 can include a linear layer and a softmax function. The linear layer can map the embeddings 866 generated by the decoder(s) 860 to a higher-dimensional space, which can transform the embeddings 866 into the original input space. The softmax function can then be applied to generate a probability distribution for each output token in the vocabulary, which can result in an output 870. In some examples, the output 870 can include output tokens with probabilities.

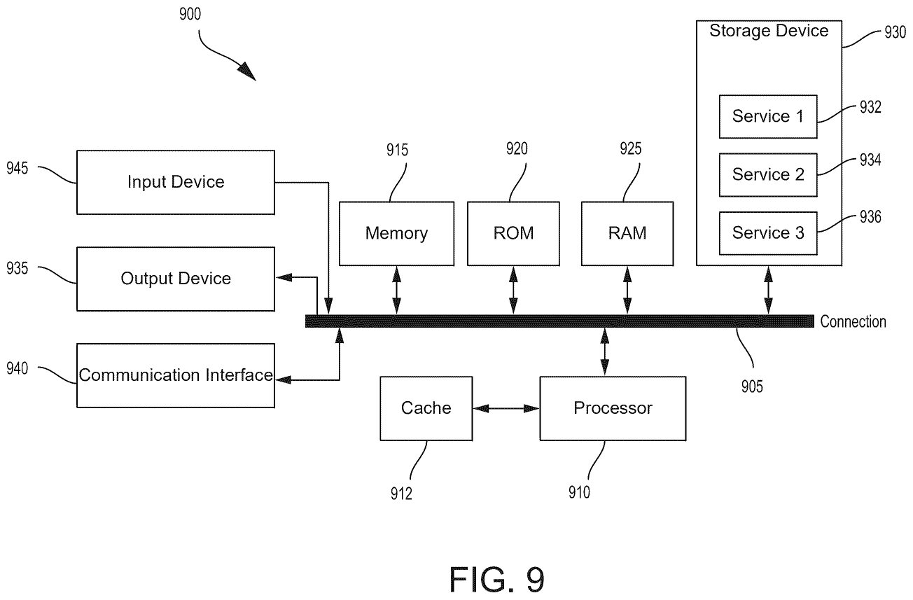

FIG. 9 illustrates an example processor-based system with which some embodiments of the subject technology can be implemented. For example, processor-based system 900 can be any computing device making up, or any component thereof in which the components of the system are in communication with each other using connection 905. Connection 905 can be a physical connection via a bus, or a direct connection into processor 910, such as in a chipset architecture. Connection 905 can also be a virtual connection, networked connection, or logical connection.

In some embodiments, computing system 900 is a distributed system in which the functions described in this disclosure can be distributed within a datacenter, multiple data centers, a peer network, etc. In some embodiments, one or more of the described system components represents many such components each performing some or all of the function for which the component is described. In some embodiments, the components can be physical or virtual devices.

Example system 900 includes at least one processing unit (Central Processing Unit (CPU) or processor) 910 and connection 905 that couples various system components including system memory 915, such as Read-Only Memory (ROM) 920 and Random-Access Memory (RAM) 925 to processor 910. Computing system 900 can include a cache of high-speed memory 912 connected directly with, in close proximity to, or integrated as part of processor 910.

Processor 910 can include any general-purpose processor and a hardware service or software service, such as services 932, 934, and 936 stored in storage device 930, configured to control processor 910 as well as a special-purpose processor where software instructions are incorporated into the actual processor design. Processor 910 may essentially be a completely self-contained computing system, containing multiple cores or processors, a bus, memory controller, cache, etc. A multi-core processor may be symmetric or asymmetric.

To enable user interaction, computing system 900 includes an input device 945, which can represent any number of input mechanisms, such as a microphone for speech, a touch-sensitive screen for gesture or graphical input, keyboard, mouse, motion input, speech, etc. Computing system 900 can also include output device 935, which can be one or more of a number of output mechanisms known to those of skill in the art. In some instances, multimodal systems can enable a user to provide multiple types of input/output to communicate with computing system 900. Computing system 900 can include communications interface 940, which can generally govern and manage the user input and system output. The communication interface may perform or facilitate receipt and/or transmission wired or wireless communications via wired and/or wireless transceivers, including those making use of an audio jack/plug, a microphone jack/plug, a Universal Serial Bus (USB) port/plug, an Apple® Lightning® port/plug, an Ethernet port/plug, a fiber optic port/plug, a proprietary wired port/plug, a BLUETOOTH® wireless signal transfer, a BLUETOOTH® low energy (BLE) wireless signal transfer, an IBEACON® wireless signal transfer, a Radio-Frequency Identification (RFID) wireless signal transfer, Near-Field Communications (NFC) wireless signal transfer, Dedicated Short Range Communication (DSRC) wireless signal transfer, 802.11 Wi-Fi® wireless signal transfer, Wireless Local Area Network (WLAN) signal transfer, Visible Light Communication (VLC) signal transfer, Worldwide Interoperability for Microwave Access (WiMAX), Infrared (IR) communication wireless signal transfer, Public Switched Telephone Network (PSTN) signal transfer, Integrated Services Digital Network (ISDN) signal transfer, 3G/4G/5G/LTE cellular data network wireless signal transfer, ad-hoc network signal transfer, radio wave signal transfer, microwave signal transfer, infrared signal transfer, visible light signal transfer signal transfer, ultraviolet light signal transfer, wireless signal transfer along the electromagnetic spectrum, or some combination thereof.

Communication interface 940 may also include one or more Global Navigation Satellite System (GNSS) receivers or transceivers that are used to determine a location of the computing system 900 based on receipt of one or more signals from one or more satellites associated with one or more GNSS systems. GNSS systems include, but are not limited to, the US-based Global Positioning System (GPS), the Russia-based Global Navigation Satellite System (GLONASS), the China-based BeiDou Navigation Satellite System (BDS), and the Europe-based Galileo GNSS. There is no restriction on operating on any particular hardware arrangement, and therefore the basic features here may easily be substituted for improved hardware or firmware arrangements as they are developed.

Storage device 930 can be a non-volatile and/or non-transitory and/or computer-readable memory device and can be a hard disk or other types of computer readable media which can store data that are accessible by a computer, such as magnetic cassettes, flash memory cards, solid state memory devices, digital versatile disks, cartridges, a floppy disk, a flexible disk, a hard disk, magnetic tape, a magnetic strip/stripe, any other magnetic storage medium, flash memory, memristor memory, any other solid-state memory, a Compact Disc (CD) Read Only Memory (CD-ROM) optical disc, a rewritable CD optical disc, a Digital Video Disk (DVD) optical disc, a Blu-ray Disc (BD) optical disc, a holographic optical disk, another optical medium, a Secure Digital (SD) card, a micro SD (microSD) card, a Memory Stick® card, a smartcard chip, a EMV chip, a Subscriber Identity Module (SIM) card, a mini/micro/nano/pico SIM card, another Integrated Circuit (IC) chip/card, Random-Access Memory (RAM), Atatic RAM (SRAM), Dynamic RAM (DRAM), Read-Only Memory (ROM), Programmable ROM (PROM), Erasable PROM (EPROM), Electrically Erasable PROM (EEPROM), flash EPROM (FLASHEPROM), cache memory (L1/L2/L3/L4/L5/L#), Resistive RAM (RRAM/ReRAM), Phase Change Memory (PCM), Spin Transfer Torque RAM (STT-RAM), another memory chip or cartridge, and/or a combination thereof.

Storage device 930 can include software services, servers, services, etc., that when the code that defines such software is executed by the processor 910, it causes the system 900 to perform a function. In some embodiments, a hardware service that performs a particular function can include the software component stored in a computer-readable medium in connection with the necessary hardware components, such as processor 910, connection 905, output device 935, etc., to carry out the function.

Embodiments within the scope of the present disclosure may also include tangible and/or non-transitory computer-readable storage media or devices for carrying or having computer-executable instructions or data structures stored thereon. Such tangible computer-readable storage devices can be any available device that can be accessed by a general purpose or special purpose computer, including the functional design of any special purpose processor as described above. By way of example, and not limitation, such tangible computer-readable devices can include RAM, ROM, EEPROM, CD-ROM or other optical disk storage, magnetic disk storage or other magnetic storage devices, or any other device which can be used to carry or store desired program code in the form of computer-executable instructions, data structures, or processor chip design. When information or instructions are provided via a network or another communications connection (either hardwired, wireless, or combination thereof) to a computer, the computer properly views the connection as a computer-readable medium. Thus, any such connection is properly termed a computer-readable medium. Combinations of the above should also be included within the scope of the computer-readable storage devices.

Computer-executable instructions include, for example, instructions and data which cause a general-purpose computer, special purpose computer, or special purpose processing device to perform a certain function or group of functions. Computer-executable instructions also include program modules that are executed by computers in stand-alone or network environments. Generally, program modules include routines, programs, components, data structures, objects, and the functions inherent in the design of special-purpose processors, etc. that perform tasks or implement abstract data types. Computer-executable instructions, associated data structures, and program modules represent examples of the program code means for executing steps of the methods disclosed herein. The particular sequence of such executable instructions or associated data structures represents examples of corresponding acts for implementing the functions described in such steps.

Other embodiments of the disclosure may be practiced in network computing environments with many types of computer system configurations, including personal computers, hand-held devices, multi-processor systems, microprocessor-based or programmable consumer electronics, network Personal Computers (PCs), minicomputers, mainframe computers, and the like. Embodiments may also be practiced in distributed computing environments where tasks are performed by local and remote processing devices that are linked (either by hardwired links, wireless links, or by a combination thereof) through a communications network. In a distributed computing environment, program modules may be located in both local and remote memory storage devices.

### SELECTED EXAMPLES

Illustrative examples of the disclosure include:

Embodiment 1. A computer-implemented method comprising: inferring, via an LLM, a response associated with performing a test in a workspace based on received input; identifying, based on the response, one or more elements in the workspace for performing the test; identifying, based on the response, one or more drivers associated with performing operations through the one or more elements in the workspace; and generating test code for automating the test based on the response and the one or more drivers.

Embodiment 2. The computer-implemented method of Embodiment 1, further comprising identifying the one or more elements by scanning a repository based on the response inferred by the LLM.

Embodiment 3. The computer-implemented method of Embodiment 2, wherein the repository is a document object model.

Embodiment 4. The computer-implemented method of any of Embodiments 1 through 3, wherein the response comprises a test file template with test steps for performing the test in the workspace.

Embodiment 5. The computer-implemented method of Embodiment 4, further comprising: performing operations of the test steps on the one or more elements through the one or more drivers according to the test file template to generate driver wrapper code for the one or more drivers; and combining the driver wrapper code with the test file template to generate the test code for the test.

Embodiment 6. The computer-implemented method of any of Embodiments 1 through 5, further comprising: identifying candidate elements for performing the test based on the response; presenting the candidate elements to a user; and receiving feedback indicative of a selected element of the candidate elements for performing the test.

Embodiment 7. The computer-implemented method of Embodiment 6, further comprising identifying the one or more drivers based on the selected element and the response to the input inferred by the LLM.

Embodiment 8. The computer-implemented method of any of Embodiments 1 through 7, wherein the workspace is identified based on either or both the input or a plugin that is accessible through the workspace and used in providing the input.

Embodiment 9. The computer-implemented method of any of Embodiments 1 through 8, further comprising storing the response inferred by the LLM in association with the generated test code.

Embodiment 10. The computer-implemented method of any of Embodiments 1 through 9, wherein the response comprises a JSON test template.

Embodiment 11. The computer-implemented method of any of Embodiments 1 through 10, further comprising: receiving feedback of the test code from the LLM; and modifying the test code based on the feedback.

Embodiment 12. The computer-implemented method of any of Embodiments 1 through 11, further comprising: receiving feedback of the test code from a user; and in response to receiving the user feedback, automatically executing the test code to perform the test in the workspace.

Embodiment 13. A system comprising: one or more processors; and at least one computer-readable storage medium having stored therein instructions which, when executed by the one or more processors, cause the one or more processors to: infer, via an LLM, a response associated with performing a test in a workspace based on received input; identify, based on the response, one or more elements in the workspace for performing the test; identify, based on the response, one or more drivers associated with performing operations through the one or more elements in the workspace; and generate test code for automating the test based on the response and the one or more drivers.

Embodiment 14. The system of Embodiment 13, wherein the response comprises a test file template with test steps for performing the test in the workspace.

Embodiment 15. The system of Embodiment 14, wherein the instructions further cause the one or more processors to: perform operations of the test steps on the one or more elements through the one or more drivers according to the test file template to generate driver wrapper code for the one or more drivers; and combine the driver wrapper code with the test file template to generate the test code for the test.

Embodiment 16. The system of any of Embodiments 13 through 15, wherein the instructions further cause the one or more processors to: identify candidate elements for performing the test based on the response; present the candidate elements to a user; and receive feedback indicative of a selected element of the candidate elements for performing the test.

Embodiment 17. The system of Embodiment 16, wherein the instructions further cause the one or more processors to identify the one or more drivers based on the selected element and the response to the input inferred by the LLM.

Embodiment 18. The system of any of Embodiments 13 through 17, wherein the instructions further cause the one or more processors to identify the one or more elements by scanning a document object model based on the response inferred by the LLM.

Embodiment 19. The system of any of Embodiments 13 through 18, wherein the instructions further cause the one or more processors to: receive feedback of the test code from a user; and in response to receiving the user feedback, automatically execute the test code to perform the test in the workspace.

Embodiment 20. A non-transitory computer-readable storage medium storing instructions for causing one or more processors to: infer, via an LLM, a response associated with performing a test in a workspace based on received input; identify, based on the response, one or more elements in the workspace for performing the test; identify, based on the response, one or more drivers associated with performing operations through the one or more elements in the workspace; and generate test code for automating the test based on the response and the one or more drivers.

Embodiment 21. A system comprising means for performing a method according to any of Embodiments 1 through 12.

The various embodiments described above are provided by way of illustration only and should not be construed to limit the scope of the disclosure. For example, the principles herein apply equally to optimization as well as general improvements. Various modifications and changes may be made to the principles described herein without following the example embodiments and applications illustrated and described herein, and without departing from the spirit and scope of the disclosure.

Claim language or other language in the disclosure reciting “at least one of” a set and/or “one or more” of a set indicates that one member of the set or multiple members of the set (in any combination) satisfy the claim. For example, claim language reciting “at least one of A and B” or “at least one of A or B” means A, B, or A and B. In another example, claim language reciting “at least one of A, B, and C” or “at least one of A, B, or C” means A, B, C, or A and B, or A and C, or B and C, or A and B and C. The language “at least one of” a set and/or “one or more” of a set does not limit the set to the items listed in the set. For example, claim language reciting “at least one of A and B” or “at least one of A or B” can mean A, B, or A and B, and can additionally include items not listed in the set of A and B.

What is claimed is:

1. A computer-implemented method comprising:
inferring, via a large language model (LLM), a response associated with performing a test in a workspace based on received input;
identifying, based on the response, one or more elements in the workspace for performing the test;
identifying, based on the response, one or more drivers associated with performing operations through the one or more elements in the workspace; and
generating test code for automating the test based on the response and the one or more drivers.

2. The computer-implemented method of claim 1, further comprising identifying the one or more elements by scanning a repository based on the response inferred by the LLM.

3. The computer-implemented method of claim 2, wherein the repository is a document object model.

4. The computer-implemented method of claim 1, wherein the response comprises a test file template with test steps for performing the test in the workspace.

5. The computer-implemented method of claim 4, further comprising:
performing operations of the test steps on the one or more elements through the one or more drivers according to the test file template to generate driver wrapper code for the one or more drivers; and
combining the driver wrapper code with the test file template to generate the test code for the test.

6. The computer-implemented method of claim 1, further comprising:
identifying candidate elements for performing the test based on the response;
presenting the candidate elements to a user; and
receiving feedback indicative of a selected element of the candidate elements for performing the test.

7. The computer-implemented method of claim 6, further comprising identifying the one or more drivers based on the selected element and the response to the input inferred by the LLM.

8. The computer-implemented method of claim 1, wherein the workspace is identified based on either or both the input or a plugin that is accessible through the workspace and used in providing the input.

9. The computer-implemented method of claim 1, further comprising storing the response inferred by the LLM in association with the generated test code.

10. The computer-implemented method of claim 1, wherein the response comprises a JavaScript Object Notation (JSON) test template.

11. The computer-implemented method of claim 1, further comprising:
receiving feedback of the test code from the LLM; and
modifying the test code based on the feedback.

12. The computer-implemented method of claim 1, further comprising:
receiving feedback of the test code from a user; and
in response to receiving the user feedback, automatically executing the test code to perform the test in the workspace.

13. A system comprising:
one or more processors; and
at least one computer-readable storage medium having stored therein instructions which, when executed by the one or more processors, cause the one or more processors to:
infer, via a large language model (LLM), a response associated with performing a test in a workspace based on received input;
identify, based on the response, one or more elements in the workspace for performing the test;
identify, based on the response, one or more drivers associated with performing operations through the one or more elements in the workspace; and
generate test code for automating the test based on the response and the one or more drivers.

14. The system of claim 13, wherein the response comprises a test file template with test steps for performing the test in the workspace.

15. The system of claim 14, wherein the instructions further cause the one or more processors to:
perform operations of the test steps on the one or more elements through the one or more drivers according to the test file template to generate driver wrapper code for the one or more drivers; and
combine the driver wrapper code with the test file template to generate the test code for the test.

16. The system of claim 13, wherein the instructions further cause the one or more processors to:
identify candidate elements for performing the test based on the response;
present the candidate elements to a user; and
receive feedback indicative of a selected element of the candidate elements for performing the test.

17. The system of claim 16, wherein the instructions further cause the one or more processors to identify the one or more drivers based on the selected element and the response to the input inferred by the LLM.

18. The system of claim 13, wherein the instructions further cause the one or more processors to identify the one or more elements by scanning a document object model based on the response inferred by the LLM.

19. The system of claim 13, wherein the instructions further cause the one or more processors to:
receive feedback of the test code from a user; and
in response to receiving the user feedback, automatically execute the test code to perform the test in the workspace.

20. A non-transitory computer-readable storage medium storing instructions for causing one or more processors to:
infer, via a large language model (LLM), a response associated with performing a test in a workspace based on received input;
identify, based on the response, one or more elements in the workspace for performing the test;
identify, based on the response, one or more drivers associated with performing operations through the one or more elements in the workspace; and
generate test code for automating the test based on the response and the one or more drivers.
